(19) United States
(12) Patent Application Publication
(10) Pub. No.: US 2005/0228803 A1
(43) Pub. Date: Oct. 13, 2005

(54) Adapter framework for line-of-business application integration

(75) Inventors: Donald M. Farmer, Woodinville, WA (US); Kamal S. Hathi, Woodinville, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/909,025

(22) Filed: Jul. 30, 2004

Related U.S. Application Data
(60) Provisional application No. 60/559,052, filed on Apr. 2, 2004.

(51) Int. Cl. G06F 17/00

(52) U.S. Cl. 707/100

(57) ABSTRACT

The present invention provides a framework to facilitate interoperability and interactions with a plurality of line-of-business (LOB) applications. In particular, maps are populated with application or system design information such as semantic and technical data. The maps are subsequently employed by the framework to enable users to interact with common and consistent semantic terminologies over a common and consistent implementation technology. Consequently, users and/or client data applications are able interact effortlessly with semantically meaningful data from a plurality of heterogeneous LOB sources.

### CROSS-REFEERENCE TO RELATED APPLICATIONS

This application claims the benefit of U.S. Provisional Application No. 60/559,052, filed Apr. 2, 2004, entitled “An Adapter Framework for Business Intelligence Tools Connectivity to Line-of-Business Software Applications,” the entirety of which is incorporated herein by reference.

### TECHNICAL FIELD

The present invention relates generally to computers and more particularly toward a framework supporting enterprise application integration and interoperability.

### BACKGROUND

Line-of-business (LOB) applications are vital technology for today's knowledge intensive businesses. LOB applications or systems can include a range or bundle of specialized systems including but not limited to accounting, enterprise resource planning (ERP), supply chain management, and customer relation management (CRM). These specific systems tie into database management systems like SQL Server and Oracle to store data. In essence, LOB applications provide crucial information concerning the pulse of a business, which is presented to users via reports or other business applications for analysis. However, these systems also employ very complex database schemas that are highly proprietary. Thus, in most vendor systems (e.g., PeopleSoft, SAP . . . ) an obscure number or string of non-descriptive alphanumeric characters identifies data structures such as a customer table. Accordingly, current LOB applications make data access and process integration extremely challenging.

LOB applications such as ERPs are mature technologies. Hence, some of the obscurity stems from the fact that the system that is now utilized generally for all types of business was originally designed with a particular industry in mind. The classic example is SAP, which was initially designed for the German chemical industry. Consequently, SAP tables and columns are labeled with up to six German chemical abbreviations. Thus, even if a user were a German chemist, they would have considerable difficulty trying to retrieve and otherwise interact with data stored by the system. Nevertheless, even newer generic applications have been designed with unintelligible notations. The consensus in the field is that notations identifying tables, columns, and rows, among other things, are deliberately obscure to discourage users from performing there own operations (e.g., extract, load) against the tables therein (e.g., customer table). Rather, users must secure the services of consultants and system integrators that understand the esoteric metadata used to identify proprietary data elements. These consultants and system integrators in turn implement their own standard deployment and configuration models for LOB applications.

Moreover, it is often common for a corporation to utilize more than one completely different system at least because a single vendor cannot meet every organizational need. For example, an organization can employ two different vendors for the same function (e.g., two different ERP systems for financials) or multiple vendors for different functions (e.g., Siebel CRM and PeopleSoft financials). As a result, the highly proprietary data models inhibit integration and interoperability. Conventionally, custom application-specific adapters written by integration vendors have been utilized to overcome this inherent limitation. These specialized adapters are employed to convert application data formats and semantics from a first sending application to a second receiving application. However, specialized adapters are very expensive and off-the-self adapters do not cover custom applications. More importantly, custom application specific adapters provide a patch not an efficient solution to the interoperability problem.

Accordingly, there is a need in the art for an efficient centralized system and method to expose or otherwise enable access to complex line-of-business data via familiar business semantics.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Briefly described, the present invention concerns facilitating integration and interoperability amongst a plurality of disparate line-of-business systems. The system of the present invention enables the capture and reuse of specialized mapping knowledge for LOB application metadata. In addition, the subject invention seeks to deliver LOB data, expressed in friendly business domain terms to a wide range of clients and facilitate high performance handling of such data for business intelligence and analysis.

According to an aspect of the invention, the system provides a map generation system and a data extraction/interaction system. The map generation system provides a means for generation of a map component that is utilized by the data extraction system to, among other things, retrieve data from one or more heterogeneous enterprise data sources and return it to a requesting client application. In particular, the map component of the subject invention includes a metadata mapping portion and a protocol mapping portion. The metadata mapping portion aliases non-descriptive enterprise source data to common business semantics whilst the protocol mapping portion is a technical mapping that, among other things, identifies the appropriate connection cartridge for interacting with a particular data source. The map generation system can produce a map component utilizing data model information published by system integrators or developed from scratch.

According to one aspect of the invention, the granularity of the published data models exposes the ability to compose objects and build custom data models or services. For instance, users can utilize a customer model and a product model to build their own sales model rather than utilizing an entire sales model as published by a particular vendor, although this is also possible.

According to another aspect of the invention, an interactive wizard can be utilized to enable a user to build a map component from published data models or manually.

In accordance with yet another aspect of the subject invention, the map component can be a data source view for mapping data in a unified dimensional model. However, other mappings are contemplated by the subject invention including but not limited to XSLT and ADL.

In brief, the subject invention not only enables users to work with friendly business semantics but it also allows them to work with a single familiar technology. Hence, both the business semantics and the technology with which users interact are consistent and familiar thereby facilitating writing code and building custom components.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

The foregoing and other aspects of the invention will become apparent from the following detailed description and the appended drawings described in brief hereinafter.

FIG. 1 is a block diagram of a data access system in accordance with an aspect of the subject invention.

FIG. 2 is a block diagram of a map builder component in accordance with an aspect of the present invention.

FIG. 3 is a block diagram of a data extraction system in accordance with an aspect of the subject invention.

FIG. 4 is block diagram of an exemplary map generation system in accordance with an aspect of the subject invention.

FIG. 5 is a block diagram of a data extraction system in accordance with an aspect of the present invention.

FIG. 6 is a graphical depiction of the enhanced user experience offered in accordance with an aspect of the present invention.

FIG. 7 depicts an exemplary GUI associated with generating a DSV in accordance with an aspect of the subject invention.

FIG. 8 illustrates an exemplary GUI associated with generating a DSV in accordance with an aspect of the subject invention.

FIG. 9a depicts an exemplary GUI associated with producing a DSV in accordance with an aspect of the present invention.

FIG. 9b illustrates an exemplary GUI associated with constructing a DSV in accordance with an aspect of the subject invention.

FIG. 9c depicts an exemplary GUI associated with generating a DSV in accordance with an aspect of the present invention.

FIG. 10 illustrates an exemplary GUI associated with producing a DSV in accordance with an aspect of the subject invention.

FIG. 11 is a GUI depicting a constructed DSV in accordance with an aspect of the present invention.

FIG. 12 is a flow chart diagram illustrating a data access methodology in accordance with an aspect of the subject invention.

FIG. 13 is a flow chart diagram of a map generation method in accordance with an aspect of subject invention.

FIG. 14 is a flow chart diagram of a data retrieval method in accordance with an aspect of the subject invention.

FIG. 15 is a schematic block diagram illustrating a suitable operating environment in accordance with an aspect of the present invention.

FIG. 16 is a schematic block diagram of a sample-computing environment with which the present invention can interact.

### DETAILED DESCRIPTION

The present invention is now described with reference to the annexed drawings, wherein like numerals refer to like or corresponding elements throughout. It should be understood, however, that the drawings and detailed description thereto are not intended to limit the invention to the particular form disclosed. Rather, the intention is to cover all modifications, equivalents, and alternatives falling within the spirit and scope of the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The term “entity,” “data entity,” or any combination or permutation thereof as used herein is intended to refer to any kind of data or metadata and more specifically to semantically rich integration domain data (e.g., “Customer” or “Purchase Order”).

Furthermore, the present invention may be implemented as a method, apparatus, or article of manufacture using standard programming and/or engineering techniques to produce software, firmware, hardware, or any combination thereof to control a computer to implement the disclosed invention. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the subject invention.

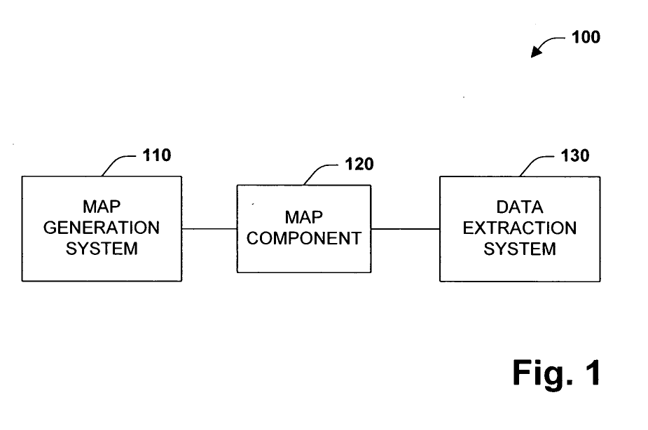

Turning initially to FIG. 1, a data access system 100 is depicted in accordance with an aspect of the subject invention. The data access system 100 is designed to, inter alia, enable the capture and reuse of specialized mapping knowledge for LOB metadata, to expose LOB data, expressed in business domain terms, to a wide range of clients, and enable high performance handling of LOB data for business intelligence and analysis. Data access system 100 comprises a map generation system 110, a map component 120, and a data extraction system 130. In particular, map generation system 110 receives design data and generates a map component 120. The map component 120 can comprise, inter alia, one or both of semantic and technical mapping information. According to an aspect of the subject invention, the map component can comprise semantic information to translate or expose obscure application specific information to friendly or meaningful business semantics. For instance, abstract notations such as a string of numbers identifying a table housing customer information can be mapped to the friendly name, “Customer Table” or the like. Furthermore, the map component 120 can comprise data to facilitate mapping application information to a single implementation technology so that users need only learn a single technology platform (e.g., .Net) or language to interact with a data stored in multiple heterogeneous data sources. More specifically, in addition to mappings (e.g., Customer.FirstName=KNA1-NAME1), the map component 120 can include entities, events, operations, and management. Entities are semantically rich integration domain data (e.g., “Customer,” “Purchase Order”). Events are outgoing API calls from a LOB application indicating changes of state of the enterprise application (e.g., customer purchase event). Operations are inbound web services to LOB applications. Management corresponds to adapter controls such as get metadata, start, stop, pause, resume, etc.

Data extraction/interaction system 130 provides a mechanism for retrieving or otherwise interacting with data (e.g., loading, modifying . . . ) maintained by a plurality of line-of-business applications. In particular, data extraction system 130 receives the map component 120 and utilizes the information therein to extract specified data from one or more enterprise systems. Data extraction system 130 can subsequently provide the retrieved information to one or more client applications for further processing, persistence, or display, among other things.

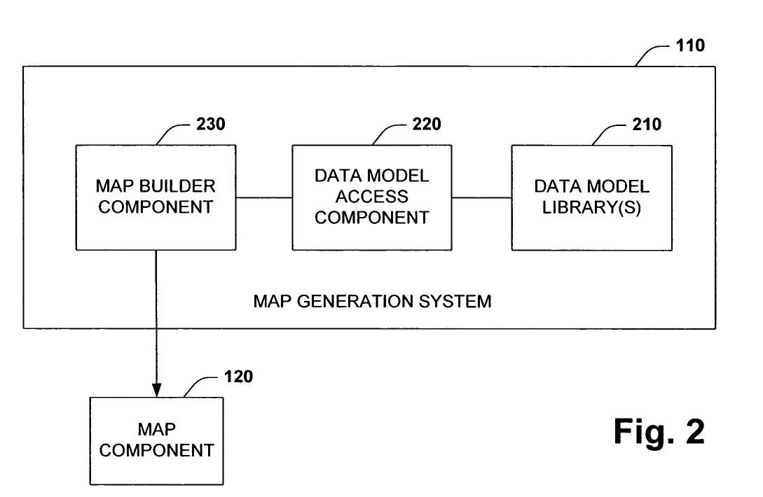

FIG. 2 illustrates a map generation system 110 in accordance with an aspect of the subject invention. As shown, map generation system 110 can include one or more data model libraries 210, a data model access component 220, and a map builder component 230. The library(s) 210 contain a plurality of mappings or mapping information for common data models (e.g., SAP, Siebel, PeopleSoft . . . ). According to one aspect of the invention, the data library can include all the mappings needed to retrieve entities from an ERP system by a given connection method as described in further detail infra. The data model access component 220 provides a mechanism for exposing data from the library 210. In particular, access component 220 retrieves data model and mapping information from the library 210 as requested by the map builder component 230 or a user. According to one aspect of the invention, it should be appreciated that the data model access component 220 can be implemented as a web service (and/or an operating system service) as the libraries can be set up as a web service, which vendors can utilize to publish their data models. The map builder component 230 can generate a map component 120 at least in part from information retrieved from the library 210. The map builder component 230 can also solicit additional design information or requirements for use in map component construction from other sources including but not limited to a user via an interface (e.g., GUI), as described further in later sections. Additionally, it should be noted that a map component can be created manually from scratch without use of library data models. Still further yet, it should be appreciated that the map component 120 can be utilized to codify system integrator deployments of LOB applications (e.g., Accenture, Arthur Anderson . . . ).

It should also be appreciated that in addition to storing LOB schema mapping definitions, the library 210 can store map components 120. Once created and named, user defined map components 120 can be saved to the data model library 210. Accordingly, generated map components can be easily reused be retrieving them from the library 210 rather than having to recreate them on demand.

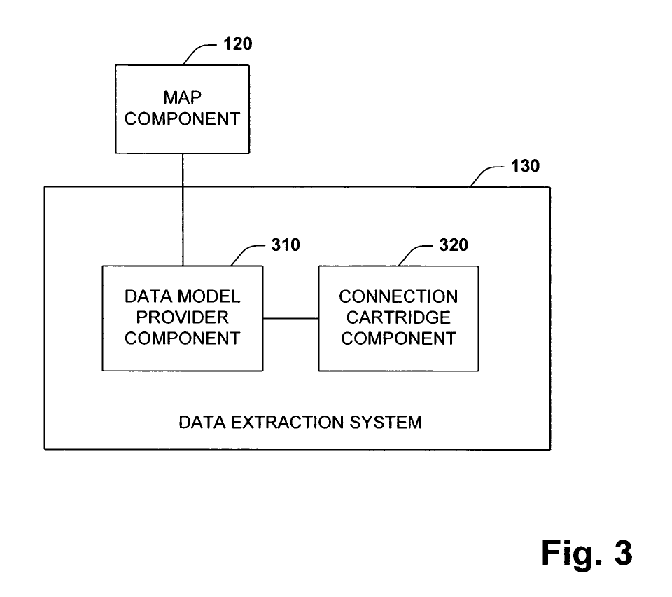

Turning to FIG. 3, a data extraction system 130 is depicted in accordance with an aspect of the subject invention. As described above, the data extraction system 130 is responsible for retrieving data entities from a plurality of different line-of-business applications and heterogeneous stores. Extraction system 130 comprises a data model provider component 310 and one or more connection cartridge components 320. Data model provider component 310 acts on the data provided by the map component 120. In particular, it provides data to clients requesting data from a LOB system by passing selected mappings from the map component 120 to the connection cartridge component 320. Connection cartridge component 320 provide a mechanism for connecting to LOB APIs (Application Programming Interfaces) or schemas and pass mappings to them in the form of queries or other request calls. There can be many different connection cartridge components 320 to enable interaction with a plurality of unique systems. In such a case, the map component can specify the particular connection cartridge component 320 to utilize to access data on a particular system. In sum, the data model provider component 310 reads models from the map component 120 and employs connection cartridge component 320 as specified by the map to extract specified data from a LOB system and subsequently provide such data to client systems.

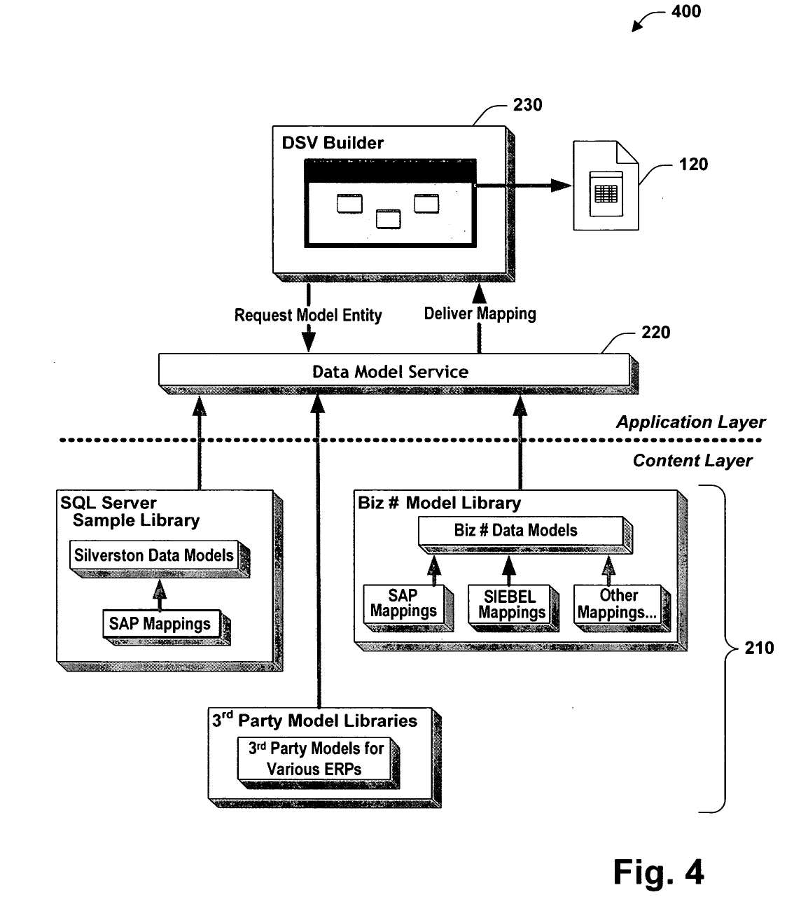

FIG. 4 illustrates an exemplary implementation of a map generation system 400 in accordance with an aspect of the subject invention. System 400 includes a DSV builder component 230, a DSV component 120, a data model service component 220 and data model libraries 210. In this system, a data source view (DSV) 120 is employed as the mapping component. A data source view is a specific technology for mapping of the unified dimensional model (UDM). The UDM is a data model defined over a set of heterogeneous data sources including but not limited to multidimensional and relational databases and data warehouses. Accordingly, the UDM facilitates access and use of the best aspects of traditional OLAP based analysis and relational reporting. The data source view is a component of the UDM for mapping thereto. For example, a DSV 120 can represent one or more business objects (e.g., customer) or an entire data model (e.g., customer sales by region). Broadly speaking, DSVs 120 are an enhanced metadata feature that, among other things, allows source metadata to be aliased to friendly terms. Data source views 120 are also robust and advantageous in that they can detect new, missing, or changed columns and can source data directly from schemas for highest bulk performance. Furthermore, DSVs 120 can reduce large amounts of data down to a smaller subset that is of particular interest. By way of example, assume a database schema has ten-thousand tables and it is desirous to work with only five or six of these tables. In the most basic scenario where a single table is needed, the user will need to scroll through thousands of tables to find the required table. That is inefficient and painful for users. The data source view 120 allows data to be cut down in to a smaller manageable subset that is of interest. As mentioned above, the DSV 120 also enables the creation of friendly names. A friendly name could be “Customer Number” rather than CuN or other cryptic names. Consequently, instead of having to search through ten-thousand tables for an abbreviation, a user can go through five relevant tables to find customer number.

The DSV 120 can be generated by the DSV builder component 230 from specified data models or manually from scratch. The data model service component 220 provides data models to the DSV component 120 from the data model library 210. By way of example and not limitation, communications between the DSV builder component 230 and the data model service component 220 can be accomplished via a web service or COM (Component Object Model) technologies. The library 210 provides data models to the service component 220 with mappings to several ERP systems. The library 210 includes all the mappings needed to retrieve data entities from an ERP system by a given connection method. For example, a library 210 can have mappings for retrieving customer data from a SAP application using OLEDB (API for linking to various data sources) and mappings for using ABAP (Advanced Business Application Programming language). This is significant in that the connection method largely defines what entities can be defined. For example, pooled tables in SAP support entities that cannot be mapped using OLEDB.

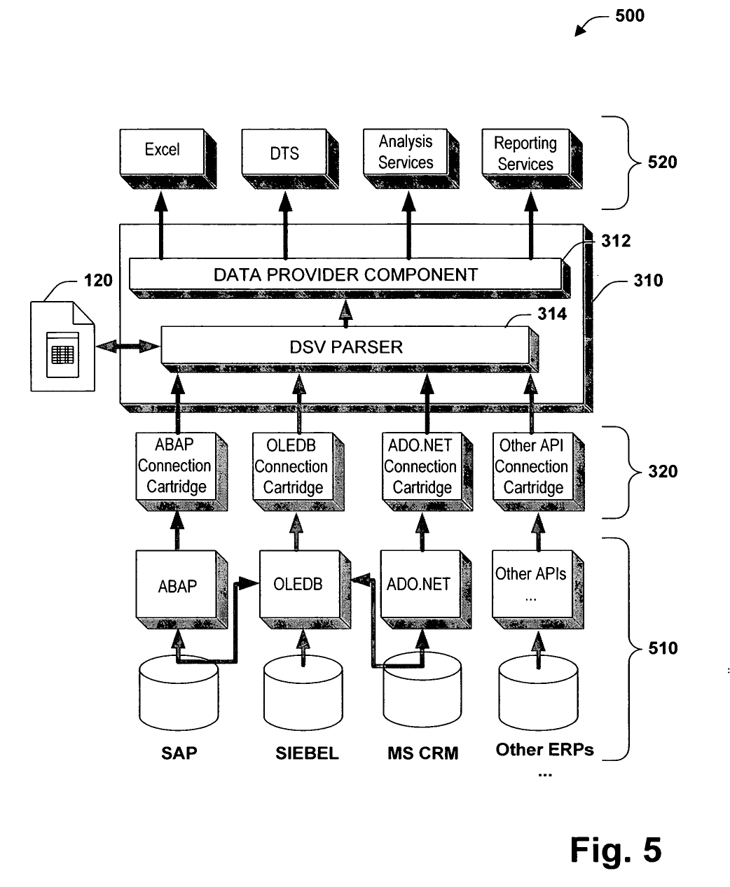

Turning to FIG. 5, an exemplary data extraction system 500 is illustrated in accordance with an aspect of the subject invention. System 500 includes a data model provider component 310, data clients 520, connection cartridge components 320 and LOB systems (and associated APIs, SDKs, schemas . . . ) 510. The data model provider component 310 facilitates data transfer between LOB systems 510 including but not limited to SAP, SIEBEL, and MS CRM, and ERP data clients such as Excel, DTS, Analysis Services, Reporting Services, and the like. If a client application wishes to retrieve and use LOB data, it can do so through the data provider 312. The data provider component 312 enables access to data and messages from LOB applications based upon the mappings defined in the DVS component 120. In other words, data provider component 312 can simply be a mechanism to facilitate interaction with data at a higher level then API calls and proprietary details. According to one aspect of the invention, an ADO.NET provider can be employed for this purpose. Upon request, the data provider can employ a DVS parser component 314 to read a DVS 120 and determine the type of connection cartridge component 320 to employ (e.g., ABAP, OLEDB, ADO.NET, . . . ). Subsequently, the appropriate connection cartridge 320 can be initialized.

The connection cartridge component 320 can provide a myriad of functions related to the passing of data. For example, the component can parse the view definitions provided by the DSV. A mapped schema can then be returned to the data provider component 312. The connection cartridge component can subsequently receive a query from the data provider 312 based on the provided schema. Then, connection details from the DSV can be used to determine appropriate data access protocol (e.g., API, direct table, messages . . . ). Data can then be retrieved from the LOB source 510 and provided to the data provider component 312 for transmission to the requesting client application 520. Accordingly, for each data entity required, the data provider 312 can pass the query mappings to the connection cartridge component 320 and retrieve data from an ERP system 510.

What has been described above is an exemplary implementation of the subject invention utilizing data source views as the mapping component 120. It should be appreciated however, that the mapping component 120 is not specific to DSVs. In fact, the mapping component 120 can be anything that allows expression of data mappings. Accordingly, the mapping component could also be implemented utilizing XSLT or ADL bucket framework to name but a few existing technologies. Furthermore, it should be appreciated that not all the components may be necessary to implement the system of the subject invention and some functionality can be executed by other components.

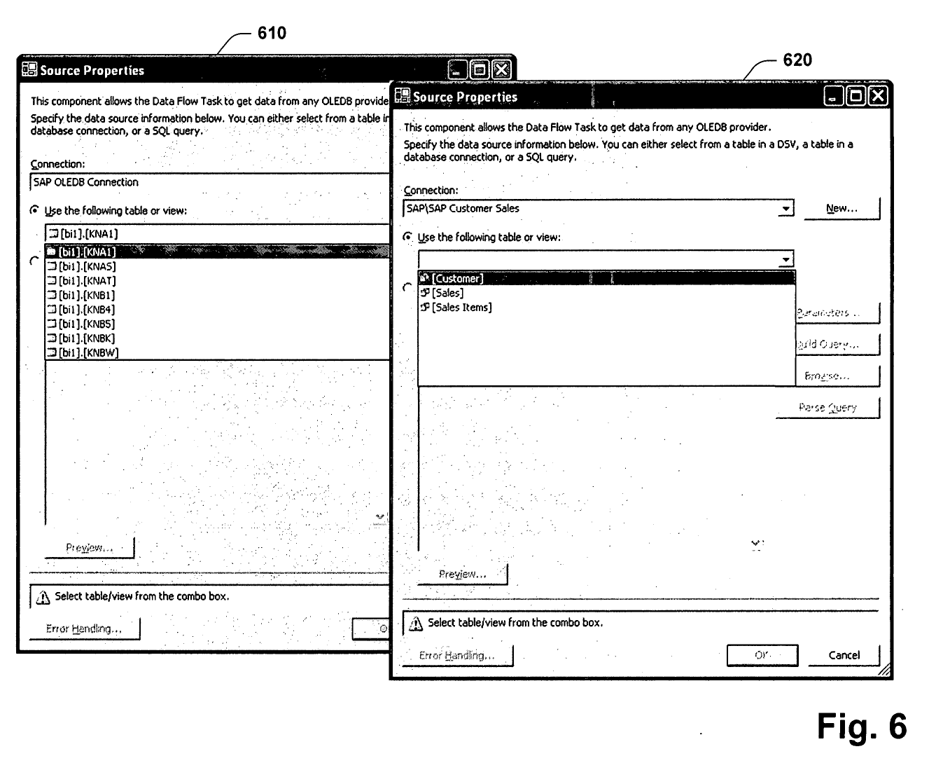

FIG. 6 is a graphical illustration of the enhanced developer experience offered in accordance with an aspect of the present invention. As shown, there are two graphical user interfaces (GUls) for extracting data from a source database, GUI 610 and GUI 620. GUI 610 illustrates a conventional interface. As can be seen from the table or view definitions, basic connectivity requires a developer to have intimate knowledge of the specific LOB application including how to join tables. GUI 620 is an exemplary GUI in accordance with an aspect of the subject invention. Here, we can see that enhanced metadata via the mapping component provides a layer of abstraction over the LOB details. Accordingly, users can focus their attention on using the LOB content, rather than trying to decipher the cryptic details of the LOB application. As appropriate, the mapping component will subsequently call APIs or operate directly against LOB database tables to interact with enterprise data.

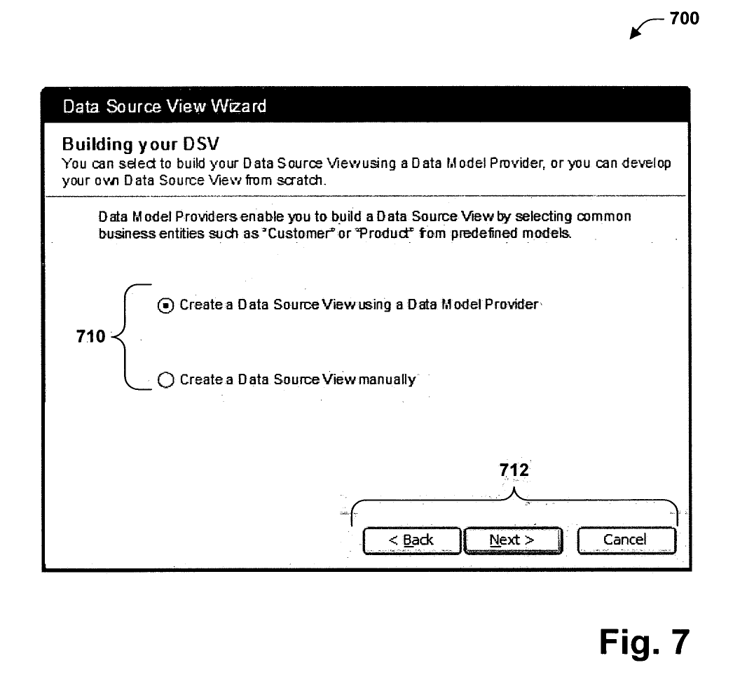

According to another aspect of the subject invention, a wizard can be employed by a user to design a mapping component or data source view 120. A wizard is a user interface (e.g., GUI) that guides a developer through a sequence of steps, wherein each step should be completed before advancing to the next step in the series unless the step is optional, of course. FIGS. 7-10 illustrate an exemplary wizard of graphical user interface that can be used to generate a data source view 120. Each figure depicts a GUI that includes a plurality of related images and interface objects or elements to facilitate guiding a user through a myriad of selection options for designing a DSV. It should be noted, however, that these illustrations are provided by way of example and not limitation. As one of skill in the art can appreciate, there is a multitude of ways to arrange and present graphical user interfaces. The depicted GUIs illustrate only one such arrangement and are presented for purposes of clarity and understanding and not to limit the scope of the subject invention.

Turning to FIG. 7 a first exemplary GUI 700 associated with generating a DSV in accordance with an aspect of the subject invention. GUI 700 provides the user/developer with an option as to how a DSV is going to be created—from scratch manually or utilizing a Data Model Provider. GUI 700 provides several buttons and switches that can be activated by a pointing and/or clicking device (e.g., mouse, trackball, touch pad, touch screen display, stylus . . . ) or keyboard. Toggle switches 710 provide the user/developer with the option of creating a DSV using a Data Model Provider or manually creating the DSV. Here, the box to create the DSV using the Data Model Provider is actuated. The buttons 712 allows a user to navigate through the wizard for instance by moving on to the “Next” step, going “Back” to a previous step, or simply terminating the wizard by clicking on “Cancel”. Clicking on “Next” provides a new GUI with additional options or selections.

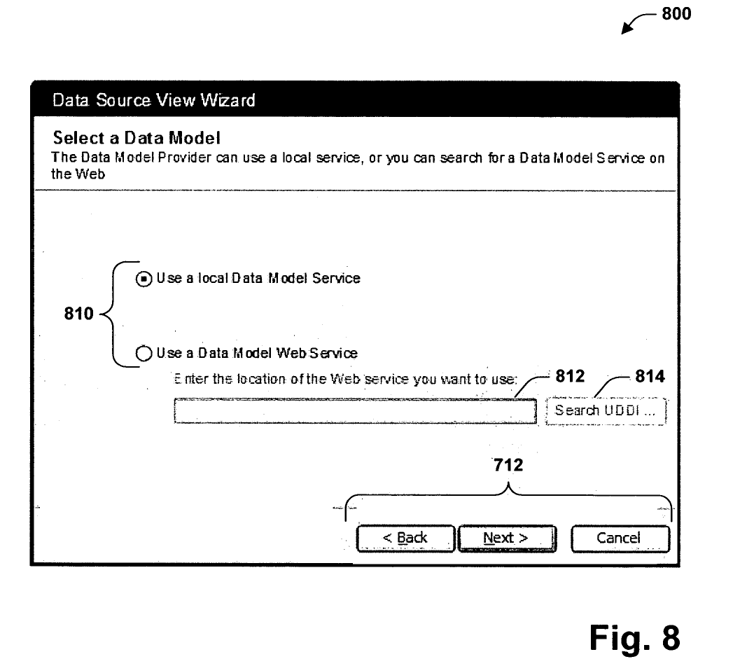

FIG. 8 illustrates a second exemplary GUI 800 associated with generating a DSV in accordance with an aspect of the present invention. GUI 800 allows a user to utilize a local data model provider service or a remote service located on the Internet, for instance, to select a data model. As illustrated, GUI 800 includes two toggle switches 810, text box 812, search button 814, and navigational buttons 712. A user can activate the respective toggle button using a pointing and/or clicking device or a keyword to indicate whether a local data model service should be employed in generating a DSV or a data model web service should be utilized. Here, the toggle associated with using a local data model service is selected. Had the other toggle be activated, a user would be required to enter the location of the web service they want to use in text box 812 or initiate a search by activating search button 814. GUI 800 also includes navigational buttons 712 to move to the next step, go back, and cancel the creation of the DSV.

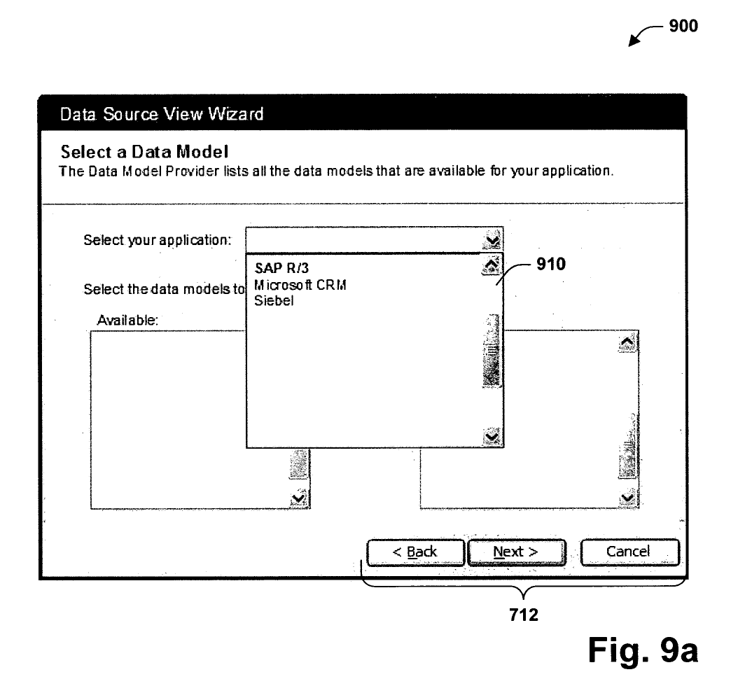

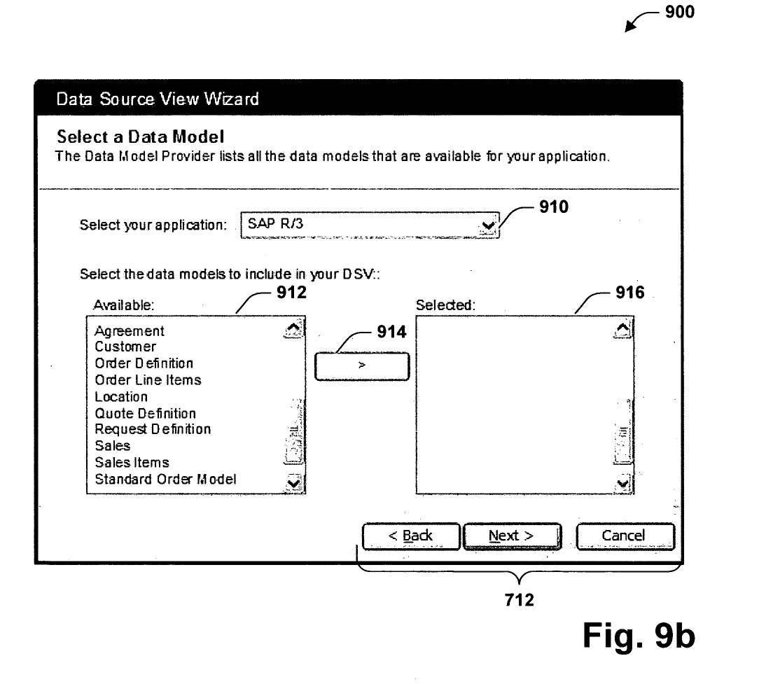

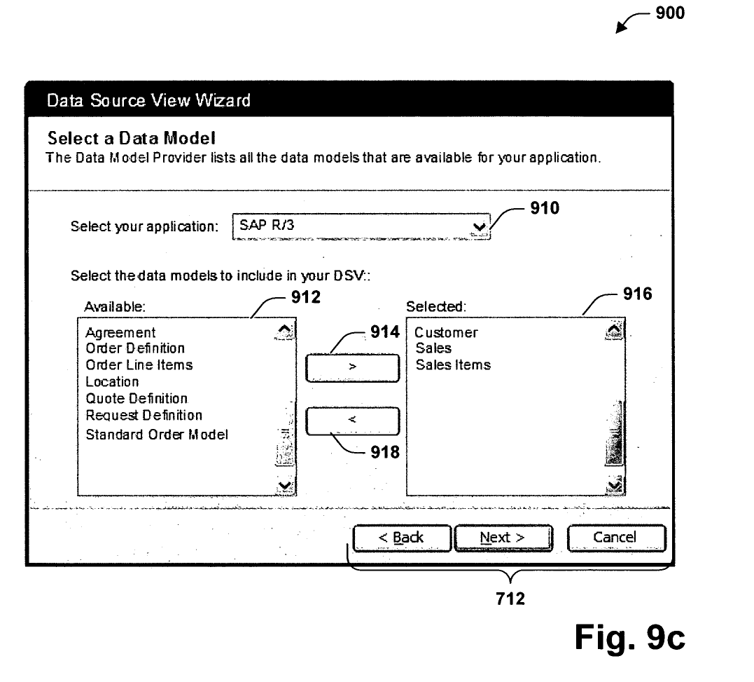

FIG. 9a is a third GUI 900 associated with creating a DSV in accordance with an aspect of the subject invention. GUI 900 enables a user to choose an application for which data models will later be selected. Here, GUI 900 provides a drop down menu 910, which provides the user with a list of selectable applications. Upon selection of an application such as SAP R/3 a list of available models data models for that application are presented in scrollable window 912 as shown in FIG. 9b. A user can then highlight one or more desired available data models in the scrollable window 912 by clicking on them with a pointing device, for example. Thereafter, the user can select the model by clicking on the selection arrow 914. Upon selection, the selected models will appear in the scrollable window 916 as shown in FIG. 9c. If a user subsequently desires to remove one or more of the selected models, he/she can again highlight the model with by appropriate means and then select remove button 918. Such action will remove the highlighted objects from window 916 and add them back to window 912. It should be appreciated that selection of items can be from more than one application thereby enabling design of a truly customized data model. However, a user can simply select an entire data model from an application (e.g., SAP R/3). Once the user has selected all the data model objects they wish to include in the DSV, navigational buttons 712 can be utilized to move on to the next step, move back a step, or cancel the DSV creation process.

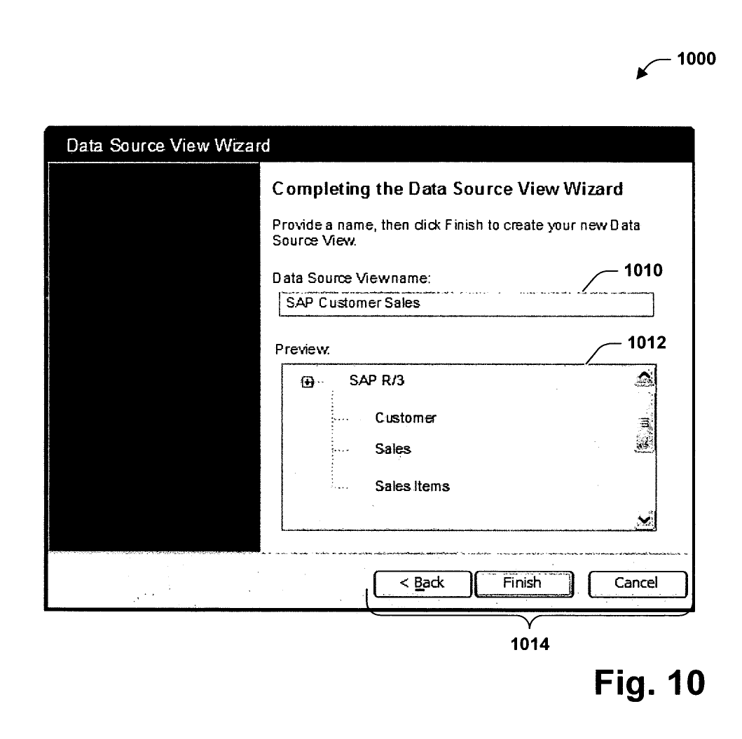

Turning to FIG. 10 a GUI 1000 is illustrated in accordance with an aspect of the subject invention. GUI 1000 provides a means for previewing and saving a data source view. In accordance therewith, a text box 1010 is provide for entering the data source view name. Furthermore, a scrollable window 1012 is supplied to allow a user to preview the created data source view. Here, three data model objects have been selected from the SAP R/3 application. Finally, navigational keys 1014 are provided to go back a step to finish creation of the DSV or cancel the DSV wizard.

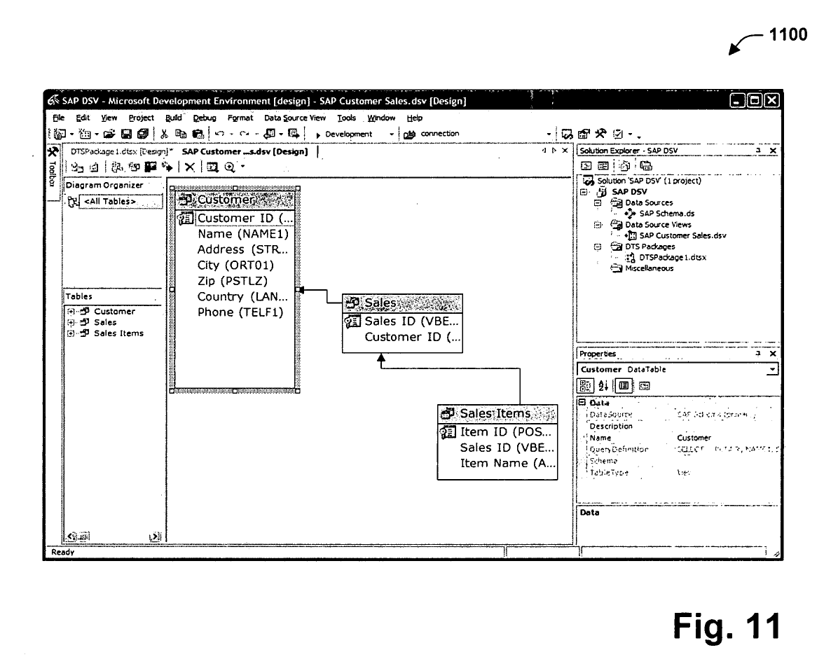

FIG. 11 illustrates a DSV development environment in accordance with an aspect of the subject invention. Here, GUI 1100 specifically depicts a constructed data source view, which was either constructed using the wizard described above or manually with the help of the development environment. The development environment can include a useful graphical interface to a plurality of tools to aid DSV construction. A data source view or map can be built for a user, employing metadata returned from the data model service component for selected objects. As illustrated, friendly names are mapped to esoteric names of the source LOB application (e.g., city and ORTO1, zip and PLSTLZ, phone and TELF1, . . . ) to facilitate interaction therewith.

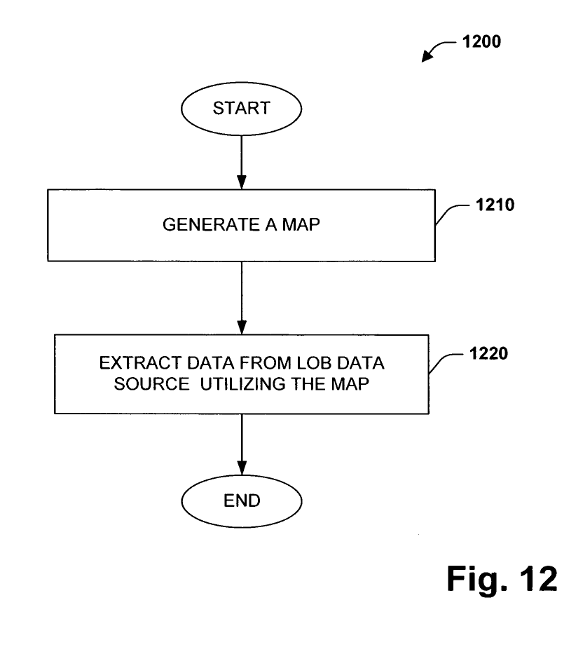

In view of the exemplary systems described supra, a methodology that may be implemented in accordance with the present invention will be better appreciated with reference to the flow charts of FIGS. 12-14. While for purposes of simplicity of explanation, the methodology is shown and described as a series of blocks, it is to be understood and appreciated that the present invention is not limited by the order of the blocks, as some blocks may, in accordance with the present invention, occur in different orders and/or concurrently with other blocks from what is depicted and described herein. Moreover, not all illustrated blocks may be required to implement the methodology in accordance with the present invention.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media.

Turning to FIG. 12, a data access methodology 1200 is depicted in accordance with an aspect of the subject invention. Methodology 1200 is especially well suited for retrieving data from a plurality of enterprise resource management systems. At 1210, a map is generated. The map can alias complex or esoteric line-of-business metadata to friendly business semantics. Furthermore, the map can be used to map a multitude of disparate enterprise systems to a single platform so that users will not have to learn several different systems to interact with data stored thereon. Rather, users can simply utilize one platform to view, retrieve, and code data on multiple systems. The map can be in any of a plurality of formats including but not limited to a data source view, XML or ADL. As such, particular mapping technologies can have additional benefits. For instance, a data source view can filter data to a subset of relevant information. At 1220, the generated map is used to extract data from a LOB data source.

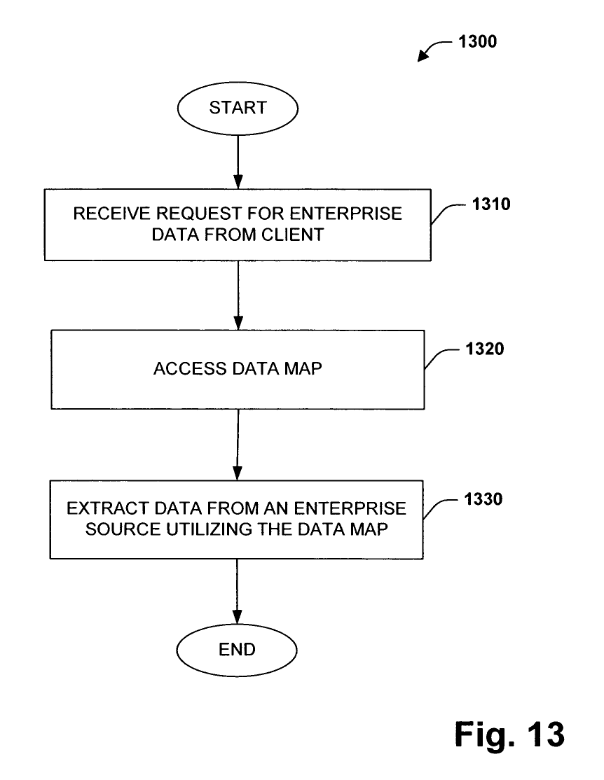

FIG. 13 depicts is a flow chart diagram of an enterprise data access method 1300 in accordance with an aspect of the subject invention. At 1310, a request is received for enterprise data from a data client. A data client can include but is not limited to Excel, DTS (Data Transformation Services), analysis services, and reporting services. The client can request data via a data provider (e.g., ADO.NET). At 1320, a data map can be accessed in response to the data request from the client. For example, the data map can be parsed and the data provider can retrieve the required connection protocols (e.g., connection cartridge, adapter . . . ) from the map, where it has been persisted along with mappings. At 1330, data can be extracted from the enterprise source(s) utilizing the mapping. In particular, for each entity required by the client, the mapping can be passed to appropriate connection cartridge(s) and data retrieved from the source(s). The retrieved data can then be returned using the data provider to the client application. In this manner, obscure source data can be retrieved from a plurality of line of business applications and exposed to the application in friendly business terms. Furthermore, a single platform can be utilized to retrieve and manipulate data. The subject invention also contemplates manipulation of data by client applications and using the map to push data back to the source.

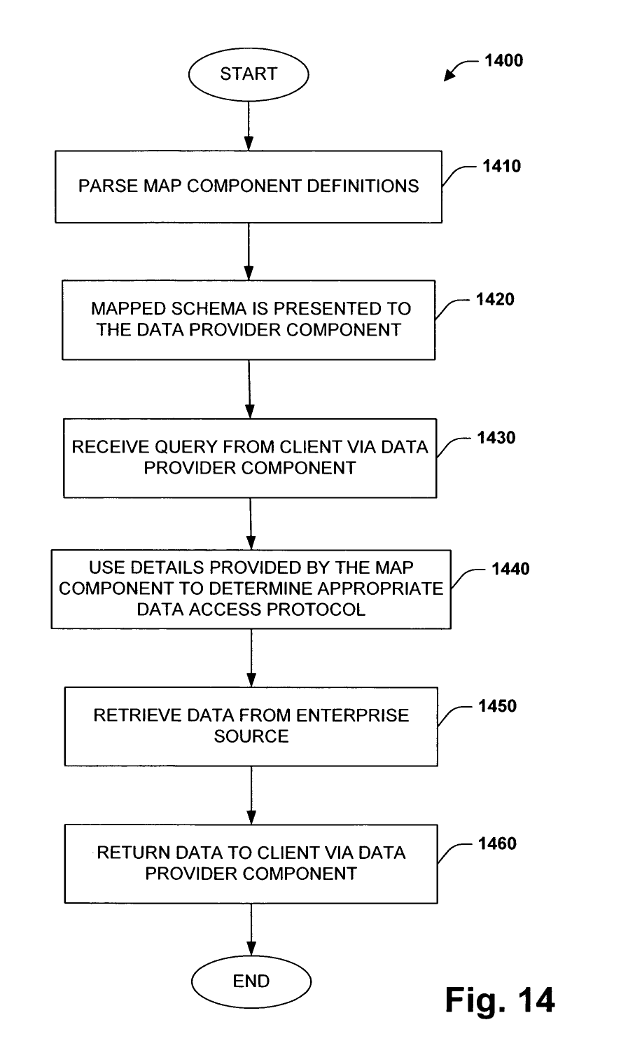

FIG. 14 depicts a method of retrieving data 1400 in accordance with an aspect of the subject invention. At 1410, map component definitions are parsed. At 1420, the mapped schema is presented to the data provider component. The mapped schema identifies data entities utilizing friendly business semantics. A query is then received, at 1430, from an enterprise client via the data provider component. At 1440, the details provided by the map component are utilized determine appropriate data access protocol/API. Utilizing the proper data access protocol(s), data is retrieved from the appropriate one or more enterprise source, at 1450. Finally, at 1460, the data is return to the client via the connection cartridge and data provider component thereby satisfying the query.

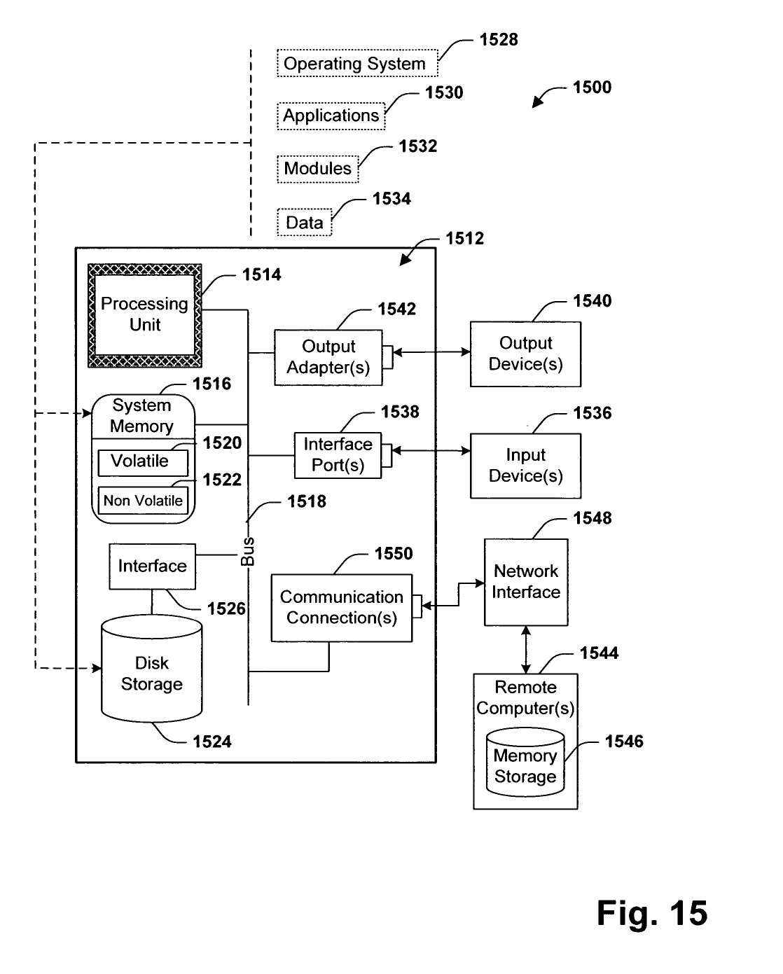

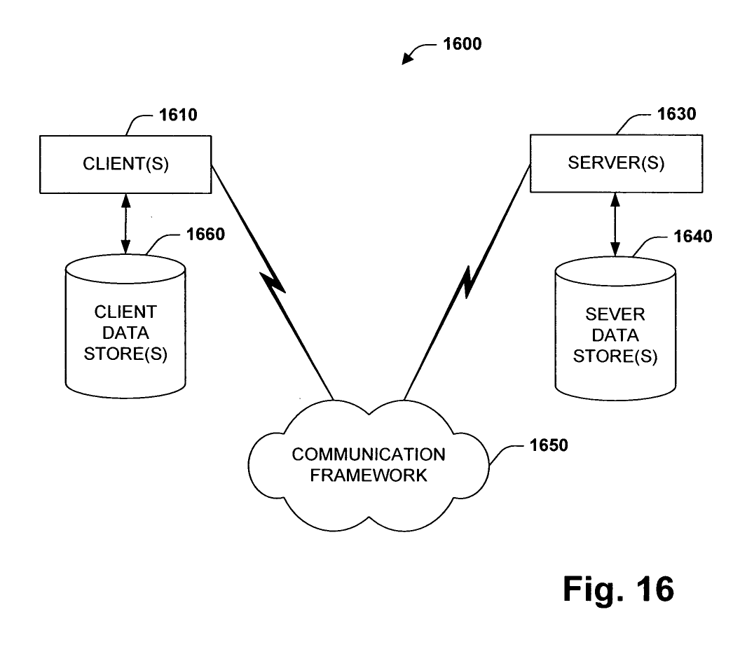

In order to provide a context for the various aspects of the invention, FIGS. 15 and 16 as well as the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

With reference to FIG. 15, an exemplary environment 1510 for implementing various aspects of the invention includes a computer 1512. The computer 1512 includes a processing unit 1514, a system memory 1516, and a system bus 1518. The system bus 1518 couples system components including, but not limited to, the system memory 1516 to the processing unit 1514. The processing unit 1514 can be any of various available processors. Dual microprocessors and other multiprocessor architectures also can be employed as the processing unit 1514.

The system bus 1518 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1516 includes volatile memory 1520 and nonvolatile memory 1522. The basic input/output system (BIOS), containing the basic routines to transfer information between elements within the computer 1512, such as during start-up, is stored in nonvolatile memory 1522. By way of illustration, and not limitation, nonvolatile memory 1522 can include read only memory (ROM), programmable ROM (PROM), electrically programmable ROM (EPROM), electrically erasable ROM (EEPROM), or flash memory. Volatile memory 1520 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1512 also includes removable/non-removable, volatile/non-volatile computer storage media. FIG. 15 illustrates, for example disk storage 1524. Disk storage 4124 includes, but is not limited to, devices like a magnetic disk drive, floppy disk drive, tape drive, Jaz drive, Zip drive, LS-100 drive, flash memory card, or memory stick. In addition, disk storage 1524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1524 to the system bus 1518, a removable or non-removable interface is typically used such as interface 1526.

It is to be appreciated that FIG. 15 describes software that acts as an intermediary between users and the basic computer resources described in suitable operating environment 1510. Such software includes an operating system 1528. Operating system 1528, which can be stored on disk storage 1524, acts to control and allocate resources of the computer system 1512. System applications 1530 take advantage of the management of resources by operating system 1528 through program modules 1532 and program data 1534 stored either in system memory 1516 or on disk storage 1524. It is to be appreciated that the present invention can be implemented with various operating systems or combinations of operating systems.

A user enters commands or information into the computer 1512 through input device(s) 1536. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536. Thus, for example, a USB port may be used to provide input to computer 1512 and to output information from computer 1512 to an output device 1540. Output adapter 1542 is provided to illustrate that there are some output devices 1540 like displays (e.g., flat panel and CRT), speakers, and printers, among other output devices 1540, that require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a personal computer, a server, a router, a network PC, a workstation, a microprocessor based appliance, a peer device or other common network node and the like, and typically includes many or all of the elements described relative to computer 1512. For purposes of brevity, only a memory storage device 1546 is illustrated with remote computer(s) 1544. Remote computer(s) 1544 is logically connected to computer 1512 through a network interface 1548 and then physically connected via communication connection 1550. Network interface 1548 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1550 refers to the hardware/software employed to connect the network interface 1548 to the bus 1518. While communication connection 1550 is shown for illustrative clarity inside computer 1512, it can also be external to computer 1512. The hardware/software necessary for connection to the network interface 1548 includes, for exemplary purposes only, internal and external technologies such as, modems including regular telephone grade modems, cable modems, power modems and DSL modems, ISDN adapters, and Ethernet cards.

FIG. 16 is a schematic block diagram of a sample-computing environment 1000 with which the present invention can interact. The system 1600 includes one or more client(s) 1610. The client(s) 1610 can be hardware and/or software (e.g., threads, processes, computing devices). The system 1600 also includes one or more server(s) 1630. The server(s) 1030 can also be hardware and/or software (e.g., threads, processes, computing devices). The servers 1630 can house threads to perform transformations by employing the present invention, for example. One possible communication between a client 1610 and a server 1630 may be in the form of a data packet adapted to be transmitted between two or more computer processes. The system 1000 includes a communication framework 1650 that can be employed to facilitate communications between the client(s) 1610 and the server(s) 1630. The client(s) 1610 are operably connected to one or more client data store(s) 1660 that can be employed to store information local to the client(s) 1610. Similarly, the server(s) 1630 are operably connected to one or more server data store(s) 1640 that can be employed to store information local to the servers 1630.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A data access system for accessing data from a line-of-business system comprising:
a data model system to provide a pre-made data model to a user, the pre-made data model modeling the line-of-business system into common business semantics:
a map generation system to generate a map that aliases source metadata to common business semantics according to the pre-made data model; and
a data exaction system that utilizes the map to extract data from the line-of-business system.

2. The system of claim 1, wherein the map comprises both semantic and technical mappings.

3. The system of claim 1, wherein the data model is presented to a user in a data source view.

4. The system of claim 1, wherein the map is an XSLT document.

5. The system of claim 1, wherein the map generation system includes;
a data model library to store data models and mapping information;
a data model access component to retrieve data from the library; and
a map builder component to generate the map at least in part from information retrieved from the library.

6. The system of claim 5, wherein the data model access component is implemented as a web service.

7. The system of claim 5, wherein the map builder component is implemented as a user interface to allow the user to customize the pre-made data model.

8. The system of claim 7, wherein the interface is a map component wizard.

9. The system of claim 5, wherein generated maps can be saved to the data model library for search and retrieval.

10. The system of claim 1, wherein the data extraction system comprises:
a data provider component; and
a connection cartridge component, wherein the data provider component extracts data from the line-of-business system utilizing the connection cartridge component.

11. The system of claim 10, wherein a map component identifies the appropriate connection cartridge component based on the data to be retrieved and the source.

12. The system of claim 10, wherein the connection cartridge component connects to line-of-business APIs and/or schemas and passes mappings to them in a form of queries defined by client applications.

13. A line-of-business data integration and interaction system comprising:
a data model component to provide a pre-built data model to a user, the pre-built data model modeling a data schema into common business semantics:
a map component that aliases non-descriptive source data to the common business semantics according to the pre-built data model and provides technical information to enable interaction with one or more line-of-business applications; and
an extraction system that utilizes information provided by the map component to connect to the one or more applications and retrieve data in response to client application queries.

14. The system of claim 13, wherein the map component is employed to facilitate customization of the pre-built data model.

15. The system of claim 13, wherein the extraction system utilizes map component information to identify and employ a connection cartridge component associated with the client application to retrieve data.

16. The system of claim 13, wherein the map component employs a data source view.

17. A computer readable medium having stored thereon computer executable components of claim 13.

18. A system for interacting with line-of-business data comprising:
a means for providing a pre-made data model to a user, the pre-made data model modeling the line-of-business data into common business semantics;
a means for providing a mapping between complex source metadata and common business semantics according to the pre-made data model; and
a means for exposing line of business source data to client applications utilizing the mapping.

19. The system of claim 18, further comprising a means for system integrators to publish data models.

20. The system of claim 18, wherein the mapping is utilized to codify system integrator deployments.

21. The system of claim 18, further comprising a means for mapping disparate line-of-business technologies to a single execution platform.

22. A method for accessing data organized in a schema comprising:
providing a pre-built data model to a user, the pre-built data model modeling the schema into business domain terms;
generating a map component to map esoteric source metadata to business domain terms according to the pre-built data model; and
extracting data from a line-of-business source utilizing the map component and a connection cartridge component identified thereby.

23. The method of claim 22, wherein the pre-built data model is customized by the user employing an interactive wizard.

24. The method of claim 22, wherein the map component maps data to a single common technical platform.

25. The method of claim 22, wherein the map component is an XSLT document.

26. The method of claim 22, wherein the map component is a data source view.

27. The method of claim 22, wherein the pre-built data model is provided by a data model access service.

28. The method of claim 27, wherein the data model access service is a web service that accesses a library of published line-of-business data models.

29. A computer readable medium having stored thereon computer executable instructions for carrying out the method of claim 22.

30. An enterprise data access methodology comprising:
providing a pre-made data model to a user, the pre-made data model modeling a schema of the enterprise data into common business terms;
receiving a request for data from an enterprise resource data client;
accessing a data map in response to the request, the data map generated in accordance with the pre-made data model; and
extracting data from at least one heterogeneous data source in accordance with the data map, the map exposing data to a client by aliasing obscure source metadata to common business terms.

31. The method of claim 30; where data map includes a protocol-mapping portion that identifies a connection cartridge that can be utilized to interface with a source SDK and/or API to retrieve data.

32. The method of claim 30, wherein the request is received from the data client via a data provider.

33. The method of claim 32, wherein the data provider is ADO.NET.

34. The method of claim 30, wherein the mapping component includes data model objects from more than one line-of-business data model.

35. A computer readable medium having stored thereon computer executable instructions for carrying out the method of claim 30.

36. An enterprise data access methodology comprising:
providing pre-defined line-of-business application data models to a user, the pre-defined line-of-business application data models mapping a schema of the enterprise data according to common business terms;
presenting mapped schema to a data provider component, the mapped schema aliasing complex application metadata to common business semantics in accordance with the pre-defined line-of-business application data models;
receiving a query from a client via the data provider component;
utilizing information provided by a map component to determine data access protocols; and
retrieving data from at least one enterprise source.

37. The method of claim 36, further comprising returning results to the client via the data provider component.

38. The method of claim 36, wherein the mapping component is defined utilizing a wizard.

39. The method of claim 38, wherein the wizard exposes predefined line-of-business application data models to users and enables them to select amongst objects associated with each respective model to include in the mapping component, the mapping component defining a customized pre-defined line-of-business application data model.

40. A computer readable medium having stored thereon computer executable instructions for carrying out the method of claim 36.
